(19) United States
(12) Patent Application Publication
(10) Pub. No.: US 2024/0387136 A1
(43) Pub. Date: Nov. 21, 2024

(54) RELAY

(71) Applicant: Xiamen Hongfa Electric Power Controls Co., Ltd, Xiamen (CN)

(72) Inventors: Wenguang Dai, Xiamen (CN); Zengguang Zheng, Xiamen (CN); Fangneng Li, Xiamen (CN); Shuming Zhong, Xiamen (CN)

(21) Appl. No.: 18/664,436

(22) Filed: May 15, 2024

(30) Foreign Application Priority Data
May 18, 2023 (CN) 2023105682519

(51) Int. Cl. H01H 50/58; H01H 50/18

(52) U.S. Cl. CPC H01H 50/58; H01H 50/18

(57) ABSTRACT

A relay includes a contact part including two sets of movable contact parts, each set including a movable contact piece, a movable contact unit, a static contact unit and a movable contact leading-out piece, at least one movable contact leading-out pieces is provided with an avoidance notch; the static contact unit having the avoidance notch including at least two static contacts; and a push rod assembly including a first and second push rods, the first push rod being movably passing through the avoidance notch of one of the movable contact leading-out pieces and connected with the movable contact piece of the other the movable contact part; the second push rod being connected with the movable contact piece of the movable contact part.

### CROSS REFERENCE

This application is based upon and claims priority to Chinese Patent Application No. 202310568251.9, filed on May 18, 2023, the entire contents thereof are incorporated herein by reference.

### TECHNICAL FIELD

The present disclosure relates to the field of electronic control device technology, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

With the continuous expansion of the application scope of the relay, the relay is also developing in the direction of high load and miniaturization. However, the temperature rise problem of the relay in the prior art has not been well solved, is prone to the accelerated aging of plastics and insulating materials inside the relay, the difficulty of arc extinguishing due to oxidation corrosion of contacts, the decay of technical parameters of electrical components, and the reduction of reliability.

### SUMMARY

In one aspect of present disclosure, a relay including:
a contact part including two sets of movable contact parts, each set of the movable contact part including a movable contact piece, a movable contact unit, a static contact unit and a movable contact leading-out piece, the movable contact unit being arranged on the movable contact piece; the static contact unit being arranged on the movable contact piece and/or the movable contact leading-out piece; two movable contact units corresponding to two static contact units, respectively; at least one of two movable contact leading-out pieces is provided with an avoidance notch; the static contact unit of the movable contact part having the avoidance notch including at least two static contacts, the movable contact unit corresponding to the static contact unit including at least two movable contacts, the at least two static contacts and the at least two movable contacts corresponding with each other; and
a push rod assembly including a first push rod and a second push rod, the first push rod being movably passing through the avoidance notch of the movable contact leading-out piece of one of the movable contact pars, the first push rod being connected with the movable contact piece of the other the movable contact part; the second push rod being connected with the movable contact piece of one of the movable contact parts.

According to some embodiments of the present disclosure, wherein in each movable contact part, the static contact unit is disposed at a connection position between the movable contact piece and the movable contact leading-out piece.

According to some embodiments of the present disclosure, wherein in each movable contact part, the movable contact piece has a first end and a second end opposite to the first end in a length direction; the movable contact unit is disposed at the first end, the static contact unit is disposed at a connection position between the second end of the movable contact piece and the movable contact leading-out piece;
the first end of one of the movable contact pieces corresponds to the second end of the other one of the movable contact pieces.

According to some embodiments of the present disclosure, wherein one of two movable contact leading-out pieces is provided with the avoidance notch, the static contact unit of the movable contact part without the avoidance notch includes one or two static contacts, the movable contact unit corresponding to the static contact unit includes one or two movable contacts.

According to some embodiments of the present disclosure, wherein the relay further includes a base, the base has an accommodation space, the accommodation space has an opening communicated with outside of the base;
the contact part is arranged in the accommodation space, the movable contact leading-out piece extends along a thickness direction of the base, and a portion of the movable contact leading-out piece extends out of the base from the opening, the thickness direction is perpendicular to the moving direction of the first push rod.

According to some embodiments of the present disclosure, wherein the relay further includes a magnetic circuit part, the magnetic circuit part drivably connected with the first push rod and the second push rod;
there are two contact parts respectively arranged on opposite sides of the magnetic circuit part, and one ends of the first push rod and the second push rod are respectively connected with two movable contact pieces of one of the contact parts; the other ends of the first push rod and the second push rod are respectively connected with two movable contact pieces of the other contact part.

According to some embodiments of the present disclosure, wherein in each contact part, at least one of two movable contact leading-out pieces is provided with the avoidance notch;
the first push rod movably passes through the avoidance notch of one of the contact parts, the second push rod movably passes through the avoidance notch of the other one of the contact parts.

According to some embodiments of the present disclosure, wherein the relay further includes a base, the base has a middle area, a first contact area and a second contact area, the middle area is arranged between the first contact area and the second contact area, the first contact area and the second contact area are spaced from each other along the first direction;
two contact parts are respectively arranged in the first contact area and the second contact area, the magnetic circuit part is arranged in the middle area.

According to some embodiments of the present disclosure, wherein the base includes:
a first partition, arranged between the first contact area and the middle area;
a second partition, arranged between the second contact area and the middle area.

According to some embodiments of the present disclosure, wherein the base further has a first moving area and a second moving area spaced from each other along the second direction, and the middle area is located between the first moving area and the second moving area; the second direction is perpendicular to the first direction.
the first push rod movably arranged in the first moving area; the second push rod movably arranged in the second moving area.

According to some embodiments of the present disclosure, wherein the first contact area, the first moving area, the second contact area and the second moving area are sequentially connected end-to-end to form a rectangular structure.

According to some embodiments of the present disclosure, wherein among the two contact parts four sets movable contact unit and the static contact unit are located at the four corners of the rectangular structure respectively.

According to some embodiments of the present disclosure, wherein the base further includes:
a third partition, arranged between the first moving area and the middle area;
a fourth partition, arranged between the second moving area and the middle area.

### BRIEF DESCRIPTION OF THE DRAWINGS

FIG. 1 illustrates a top schematic view of a relay according to an embodiment of the present disclosure, with the upper cover omitted.

FIG. 2 shows a three-dimensional view of a base in FIG. 1.

FIG. 3 shows a schematic view of the relay of FIG. 1 with the base omitted.

FIG. 4 shows a cross-sectional view of the magnetic circuit part.

FIG. 5 is a three-dimensional view of the first push rod, the second push rod and one of the contact parts assembled.

FIG. 6 is a three-dimensional view of the magnetic circuit part, the push rod assembly and one of the contact parts after assembled.

FIG. 7 shows a cross-sectional view of the relay by the plane formed by the first direction and the thickness direction.

FIG. 8 is an exploded view of the movable contact part, in which the movable contact leading-out piece is provided with the avoidance notch.

wherein, the reference numerals are listed as follows:
10: base
101: bottom plate
102: side wall
110: middle area
120: first contact area
130: second contact area
140: first moving area
150: second moving area
161: first partition
162: second partition
163: third partition
164: fourth partition
170: accommodation space
180: opening
20: contact part
20a: movable contact part
210: movable contact piece
211: sub-contact piece
210a: first end
210b: second end
220: movable contact unit
221: movable contact
230: static contact unit
231: static contact
240: movable contact leading-out piece
241: avoidance notch
30: magnetic circuit part
310: coil assembly
320: armature assembly
321: permanent magnet
322: armature
323: swinging arm
40: push rod assembly
410: first push rod
420: second push rod
50: pin
D1: first direction
D2: second direction
D3: thickness direction

### DETAILED DESCRIPTION

Now, the exemplary implementations will be described more completely with reference to the accompanying drawings. However, the exemplary implementations can be done in various forms and should not be construed as limiting the implementations as set forth herein. Instead, these implementations are provided so that the present disclosure will be thorough and complete, and concept of the exemplary implementation will be fully conveyed to those skilled in the art. Same reference numbers denote the same or similar structures in the Figures, and thus the detailed description thereof will be omitted.

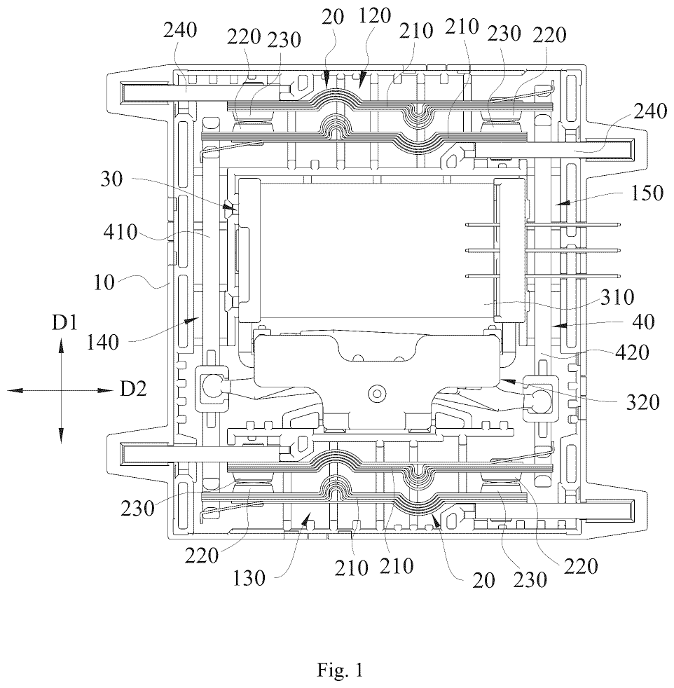

As shown in FIGS. 1-3, a relay according to the embodiments of the present disclosure includes a base 10, a pair of contact parts 20, a magnetic circuit part 30, and a push rod assembly 40. The pair of contact parts 20 and the magnetic circuit part 30 are disposed on the base 10 The magnetic circuit part 30 drives contacts of the pair of contact parts 20 to connect or disconnect through the push rod assembly 40.

It is understood that the terms “include” and “have” and their any variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

It should be noted that in other implementations, the contact part 20 may be only one, and the contact part 20 is arranged on one side of the magnetic circuit part 30. The magnetic circuit part 30 drives the contacts of the contact part 20 to connect or disconnect through the push rod assembly 40.

The base 10 may include a bottom plate 101 and the side wall 102 connected to the periphery of the bottom plate 101. The side wall 102 and the bottom plate 101 enclose an accommodation space 170 for accommodating the pair of contact part 20, the magnetic circuit part 30 and the push rod assembly 40. The accommodation space 170 is provided with the an opening 180 which communicates with the outside of the base 10. The base 10 is used to connect with a cover (not shown in the Figure), which encloses the opening 180.

In one embodiment, the base 10 may be substantially cubic in shape, but is not limited thereto.

The base 10 has a middle area 110, a first contact area 120 and a second contact area 130. The middle area 110 is arranged between the first contact area 120 and the second contact area 130, and the first contact area 120 and the second contact area 130 are arranged spaced from each other along the first direction D1.

A pair of contact parts 20 may be respectively disposed inside the first contact area 120 and the second contact area 130.

That is, two contact part 20 are arranged in the base 10 spaced from each other in first direction D1.

Each contact part 20 includes two sets of movable contact parts 20a. Each set of movable contact parts 20a includes a movable contact piece 210, a movable contact unit 220, and a static contact unit 230. The movable contact piece 210 has a first end 210a and a second end 210b disposed oppositely in the second direction D2. The movable contact unit 220 is disposed on the first end 210a, and the static contact unit 230 is disposed on the second end 210b. The two movable contact units 220 of each contact part 20 correspond to the two static contact units 230 respectively. Where the second direction D2 is perpendicular to the first direction D1.

The magnetic circuit part 30 is disposed on the middle area 110 of the base 10 and is used to drive the movement of four movable contact pieces 210 of the pair of contact parts 20 through the push rod assembly 40, thereby connecting and disconnecting the movable contact units 220 and the static contact units 230.

It is understood that the relay of the embodiments of the present disclosure includes a pair of contact parts 20. Each contact part 20 can control one circuit, so that the relay of the embodiments of the present disclosure can control at least two circuits. Two contact parts 20 are arranged on the base 10 spaced with each other in the first direction D1.

Wherein each contact part 20 includes two sets movable contact parts 20a, and the structural design of the movable contact parts 20a are basically the same. Two sets movable contact parts 20a are approximately parallel with each other, and each includes a movable contact piece 210, a movable contact unit 220 and a static contact unit 230.

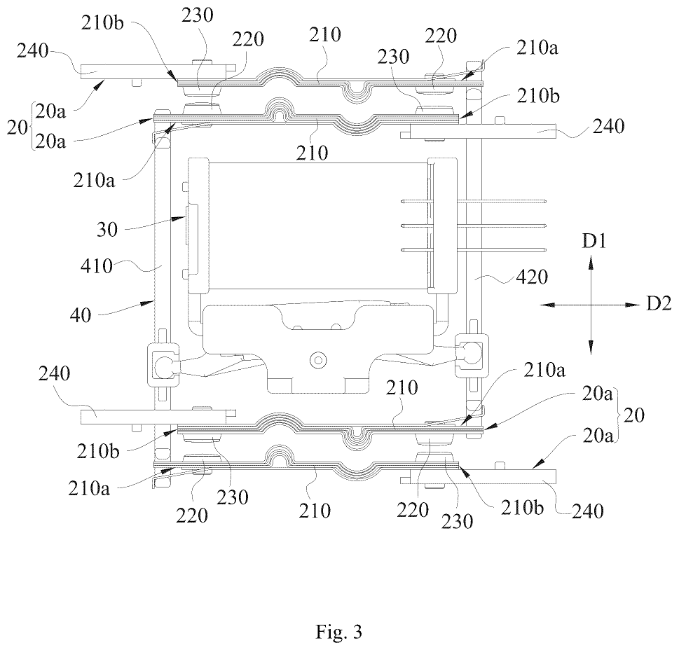

Two sets movable contact part 20a are arranged oppositely in the second direction D2. Specifically, as shown in FIGS. 1 and 3, the contact part 20 located in the first contact area 120 will be taken as an example for explanation. Two movable contact pieces 210 in two sets movable contact part 20a are approximately parallel. The first end 210a of one of the movable contact pieces 210 corresponds to the second end 210b of the other movable contact piece 210, the second end 210b of one of the movable contact pieces 210 corresponds to the first end 210a of the other movable contact piece 210. Since the movable contact unit 220 is disposed on the first end 210a of the movable contact piece 210, and the static contact unit 230 is disposed on the second end 210b of the movable contact piece 210. Thus, the movable contact unit 220 in one set movable contact part 20a corresponds to the static contact unit 230 in the other set movable contact part 20a, and the static contact unit 230 of one set movable contact part 20a corresponds to the movable contact unit 220 of the other set movable contact part 20a. Therefore, when the magnetic circuit part 30 drives the movable contact piece 210 to move through the push rod assembly 40, two pair movable contact units 220 and static contact units 230 in one set movable contact part 20a contact to form a circuit structure in parallel.

It is understood that, during the action of the relay, the movable contact piece 210 is both an action part and a current carrier, therefore, the movable contact piece 210 is a part that is easy to generate temperature rise in the relay.

In the relay of the embodiment of the present invention, two contact parts 20 are spaced from each other on the first direction D1, and in each contact part 20, two sets movable contact unit 220 and the static contact unit 230 are spaced from each other on the second direction D2. On the whole, two contact part 20 are located in the first contact area 120 and the second contact area 130 of the base 10, respectively. And is separated by the magnetic circuit part 30 located in the middle area 110 of the base 10, therefore, the influence of thermal radiation generated by one contact part 20 on the other contact part 20 is effectively reduced. As for the contact part 20 separately, two sets movable contact unit 220 and the static contact unit 230 in each contact part 20 are spaced from each other along the second direction D2. Since the movable contact unit 220 is located at the first end 210a of the movable contact piece 210, the static contact unit 230 is located at the second end 210b of the movable contact piece 210, so on the second direction D2, the distance between two sets movable contact unit 220 and the static contact unit 230 in each contact part 20 is also as large as possible. The influence of heat radiation generated by one of the sets movable contact unit 220 and the static contact unit 230 on the other set movable contact unit 220 and the static contact unit 230 is reduced. To sum up, by arranging two contact part 20 spaced from each other in the first direction D1, The structural design of two sets movable contact unit 220 and the static contact unit 230 in each contact part 20 on the second direction D2 effectively reduces the temperature rise of the whole relay and improves the reliability and service life of the relay.

With continued reference to FIGS. 1 to 3, each set movable contact part 20a further includes a movable contact leading-out piece 240 connected to the movable contact piece 210. In each set movable contact part 20a, the static contact unit 230 is located at the connection position of the second end 210b of the movable contact piece 210 and the movable contact leading-out piece 240.

In other embodiments, in each set movable contact part 20a, the static contact unit 230 can also be disposed on the movable contact leading-out piece 24; or the static contact unit 230 is disposed on the movable contact piece 210, and adjacent to the movable contact leading-out piece 240.

The length of the movable contact piece 210 extends along the second direction D2, thus the first end 210a and the second end 210b of the movable contact piece 210 are disposed oppositely on the length direction of the movable contact piece 21. Therefore, the distance between the movable contact unit 220 and the static contact unit 230 arranged on the movable contact piece 210 can be as large as possible, and the influence of heat radiation between two sets movable contact unit 220 and the static contact unit 230 can be reduced.

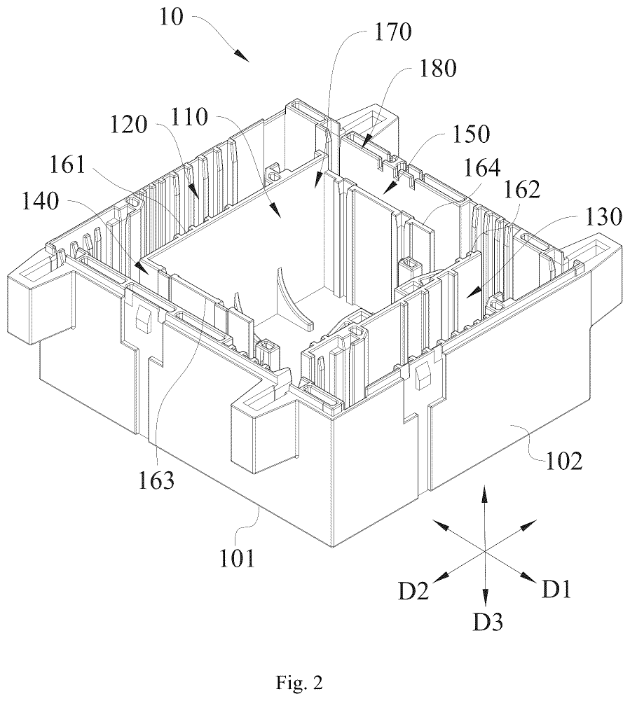

With continued reference to FIGS. 1 to 2, the base 10 includes a first partition 161 and a second partition 162, the first partition 161 is connected to the bottom plate 101 and between the first contact area 120 and the middle area 110. the second partition 162 is connected to the bottom plate 101 and between the second contact areal 30 and the middle area 110. Through the design of the first partition 161 and the second partition 162, The first partition 161 separates one of the contact part 20 from the magnetic circuit part 30, The second partition 162 separates the other contact part 20 from the magnetic circuit part 30, so that the thermal radiation generated by one contact part 20 is blocked by the first partition 161. The thermal radiation generated by the other contact part 20 is blocked by the second partition 162, thus avoiding the mutual influence of the thermal radiation generated by the two contact parts 20.

With continued reference to FIGS. 1 to 2, the base 10 also has a first moving area 140 and a second moving area 150 spaced from each other along the second direction D2, and the middle area 110 is located between the first moving area 140 and the second moving area 150.

The push rod assembly 40 includes a first push rod 410 and a second push rod 420. The magnetic circuit part 30 is drivable connected with the first push rod 410 and the second push rod 420, respectively, so as to drive the movement of the first push rod 410 at the first moving area 140 and the movement of the second push rod 420 at the second moving area 150.

As shown in FIG. 3, One end of the first push rod 410 is connected to the first end 210a of one of the movable contact pieces 210 in the contact parts 20 disposed in the first contact area 120, and the other end of the first push rod 410 is connected to the first end 210a of the other of the movable contact pieces 210 in the contact parts 20 disposed in the second contact area 130. One end of the second push rod 420 is connected to the first end 210a of the other of the movable contact pieces 210 in the contact part 20 disposed in the first contact area 120, and the other end of the second push rod 420 is connected to the first end 210a of the other of the movable contact pieces 210 in the contact parts 20 disposed in the second contact area 130.

In this embodiment, the push rod assembly 40 adopts a dual push rod structure with the first push rod 410 and the second push rod 420, and the connecting or disconnecting of the contacts can be achieved through the push-pull movement of the dual push rod structure.

Specifically, the movement directions of the first push rod 410 and the second push rod 420 are opposite. If the first push rod 410 moves downwards, then the second push rod 420 moves upwards. Since the first push rod 410 moves downwards, the two movable contact pieces 210 connect to the first push rod 410, both pivots move downwards around their respective second ends 210b. Since the second push rod 420 moves upwards, the two movable contact pieces 210 connect to the second push rod 420, both pivots move upwards around their respective second ends 210b. In one contact part 20, the two movable contact pieces 210 pivot in opposite directions and move away from each other, thereby achieving the disconnection of the movable contact unit 220 and the static contact unit 230.

Conversely, if the first push rod 410 moves upwards, then the second push rod 420 moves downwards. The two movable contact pieces 210 connects to the first push rod 410, both pivots move upwards around their respective second ends 210b, and the two movable contact pieces 210 connect to the second push rod 420, both pivots move downwards around their respective second ends 210b. In one contact part 20, the two movable contact pieces 210 pivot in opposite directions and move towards each other, achieving the connection of the movable contact unit 220 and the static contact unit 230.

The base 10 further includes a third partition 163 and a fourth partition 164. the third partition 163 is connected to the bottom plate 101 and between the first moving area 140 and the middle area 110. the fourth partition 164 is connected to the bottom plate 101 between the second moving area 150 and the middle area 110.

As shown in FIGS. 1 and 2, the first contact area 120, the first moving area 140, the second contact area 130 and the second moving area 150 are connected end-to-end to form a rectangular structure. The magnetic circuit part 30 is located in the rectangular structure, two contact part 20 are located at two opposite sides of the rectangular structure, and the first push rod 410 and the second push rod 420 are located at the other two opposite sides of the rectangular structure.

In the pair of contact pars 20, four sets movable contact unit 220 and the static contact unit 230 are located at four corners of the rectangular structure respectively. In this way, four sets movable contact unit 220 and the static contact unit 230 are respectively arranged at four corners of the rectangular structure so as to widen the distance between the sets movable contact unit 220 and the static contact unit 230, and effectively reduce the thermal radiation influence between two adjacent sets movable contact unit 220 and the static contact unit 230.

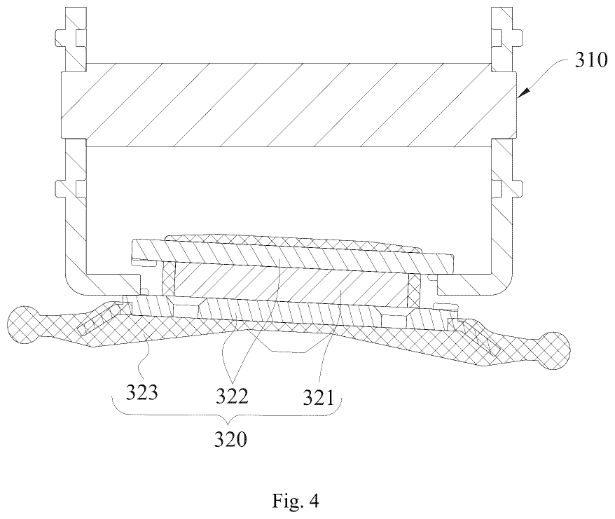

As shown in FIG. 4, the magnetic circuit part 30 includes a coil assembly 310 and an armature assembly 320, the armature assembly 320 is pivotally connected to the base 10 under the magnetic driving action of the coil assembly 310. The armature assembly 320 includes a permanent magnet 321, an armature 322, and a swinging arm 323. There are two armatures 322, and the permanent magnet 321 is clamped between the two armatures 322. The swinging arm 323 may be made of an insulating material, such as plastic. The permanent magnet 321, the armature 322, and the swinging arm 323 may be integrally connected by an injection molding. Two ends of the swinging arm 323 are respectively connected to the first push rod 410 and the second push rod 420.

By changing a direction of a magnetic field of the coil assembly 310 to drive the armature assembly 320 to pivot relative to the base 10. The swinging arm 323 of the armature assembly 320 respectively drive the reciprocated movement of the first push rod 410 and the second push rod 420 along the first direction D1, so as to achieve the connection or disconnection of the movable contact unit 220 and the static contact unit 230.

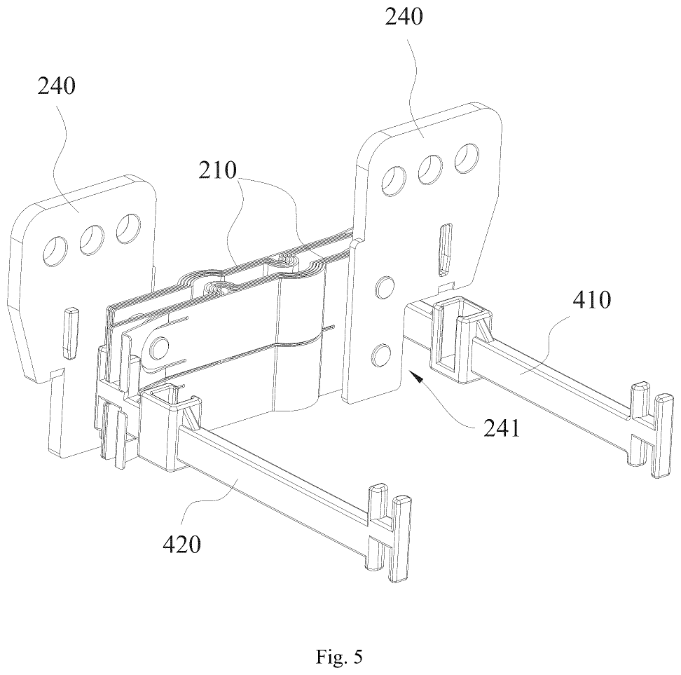

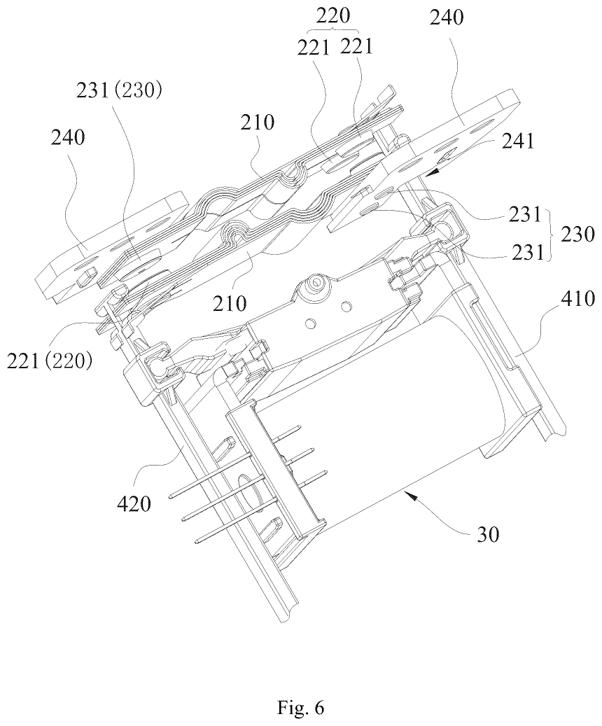

As shown in FIGS. 5 and 6, at least one of the two movable contact leading-out pieces 240 in one contact part 20 is provided with an avoidance notch 241. the static contact unit 230 of the movable contact part 20a provided with the avoidance notch 241 at least includes two static contacts 231, the movable contact unit 220 corresponding to the static contact unit 230 includes two movable contacts 221, the at least two static contacts 231 correspond to the at least two movable contact 221. the first push rod 410 movably passes through the avoidance notch 241 of the movable contact leading-out piece 240 in one movable contact part 20a, and the first push rod 410 is connected to the movable contact piece 210 of the other movable contact part 20a. the second push rod 420 is connected to the movable contact piece 210 of one of the movable contact parts 20.

It is understood that, the relay in the embodiment of the present invention adopts a double push rod structure consisting of the first push rod 410 and the second push rod 420. When assembling the first push rod 410, the second push rod 420 and the contact part 20, In order to reduce the volume of the relay, at least one movable contact leading-out piece 240 in the contact part 20 needs to give way, that is, the movable contact leading-out piece 240 is provided with the avoidance notch 241, which can be movably inserted by the first push rod 410. In this way, the relay is more compact on the second direction D2 and will not increase the volume of the relay.

Further, since the movable contact leading-out piece 240 is provided with the avoidance notch 241, the cross-sectional area where the movable contact leading-out piece 240 is provided with the avoidance notch 241 carries a higher current, which is not conducive to reducing the temperature rise.

In the relay of the embodiment of the present invention, at least one of two movable contact leading-out pieces 240 in one contact part 20 is provided with the avoidance notch 241. The avoidance notch 241 can be movably inserted into the first push rod 410, which plays a role in giving way. At the same time, the static contact unit 230 of the movable contact part 20a provided the avoidance notch 241 includes at least two static contacts 231, the movable contact unit 220 corresponding to the static contact unit 230 includes at least two movable contacts 221, at least two static contacts 231 correspond to at least two movable contact 221, In this way, the contacts near the movable contact leading-out piece 240 with the avoidance notch 241 form a multi-contact parallel structure, which is beneficial to reduce the temperature rise. Therefore, the relay of the embodiment of the present invention adopts the combination of the avoidance notch 241 and multi-contacts, and on the basis that the movable contact leading-out piece 240 can give way to the push rod assembly, It can also improve the local temperature rise caused by the high current-carrying cross-sectional area caused by the movable contact leading-out piece 240 with the avoidance notch 241, and ensure the performance of the product.

Please continue to refer to FIGS. 5 and 6. In one contact part 20, the movable contact leading-out piece 240 of the movable contact part 20a located at the inner side is provided with the avoidance notch 241, and the movable contact leading-out piece 240 located at the outer side of the movable contact part 20a is not provided with the avoidance notch 241. The movable contact part 20a near the magnetic circuit part 30 is defined as the inner movable contact part 20a, and the movable contact part 20a far away from the magnetic circuit part 30 is defined as the outer movable contact part 20a. For convenience of explanation, two movable contact parts 20a of the contact part 20 are named as the inner movable contact part 20a and the outer movable contact part 20a, respectively.

When there are two contact parts 20, the movable contact leading-out pieces 240 of two inner movable contact parts 20a are both provided with the avoidance notch 241. The movable contact leading-out pieces 240 of two outer movable contact parts 20a are not provided with the avoidance notch 241. The first push rod 410 movably passes through the avoidance notch 241 of one of the inner movable contact parts 20a, and the second push rod 420 movably passes through the avoidance notch 241 of the other inner movable contact part 20a.

In this embodiment, the static contact unit 230 of the inner movable contact part 20a includes two static contact 231, and the movable contact unit 220 includes one movable contact 221. The movable contact unit 220 of the outer movable contact part 20a includes two movable contacts 221, and the static contact unit 230 includes one static contact 231. The two static contacts 231 of the inner movable contact part 20a correspond to the two movable contacts 221 of the outer movable contact part 20a to form two sets contact sets. A static contact 231 of the inner movable contact part 20a corresponds to a movable contact 221 of the outer movable contact part 20a to form a set contact set. That is, the number of the contact sets near the avoidance notch 241 is two, while the number of the contact sets far away from the avoidance notch 241 is one.

Of course, in other implementations, the number of the contact sets near the avoidance notch 241 can also be three or four, and the number of the contact sets far away from the avoidance notch 241 can also be two.

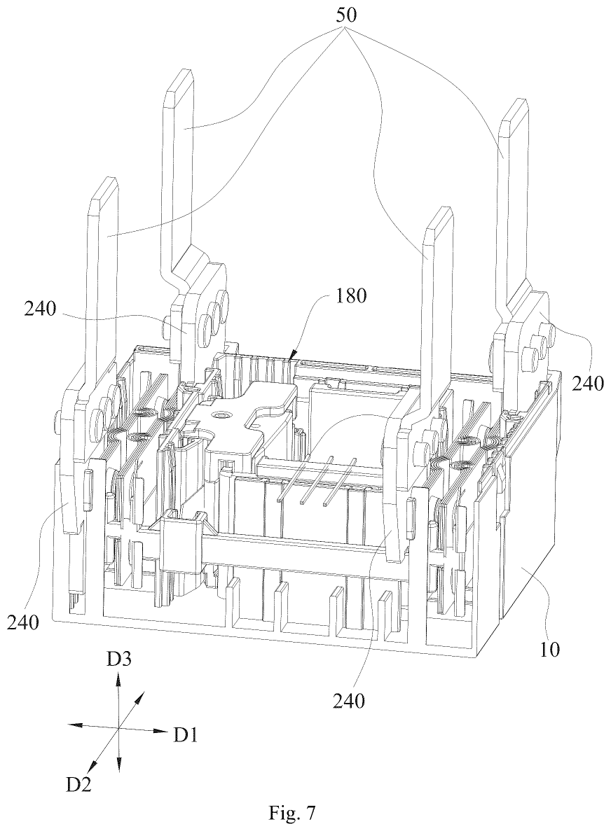

As shown in FIG. 7, the movable contact leading-out pieces 240 extend along the thickness direction D3 of the base 10, and portions of the movable contact leading-out pieces 240 extend out of the base 10 from the opening 180 for connecting with the pins 50. The pins 50 also extends along the thickness direction D3. The thickness direction D3 is perpendicular to the moving direction of the first push rod 410. In other words, the thickness direction D3 is perpendicular to the first direction D1 and the second direction D2.

In this embodiment, the movable contact leading-out pieces 240 extend along the thickness direction D3 of the base 10 toward the opening 180 of the base 10 and extend out of the base 10 from the opening 180. In this way, the size of the movable contact leading-out pieces 240 in the thickness direction D3 will become larger, so as to make up for the problem of too high current-carrying per unit cross-sectional area caused by setting the avoidance notch 241 and improve the problem of too high temperature rise. Moreover, because two movable contact pieces 210 in one contact part 20 are arranged in parallel, therefore, two movable contact leading-out pieces 240 connected with two movable contact pieces 210 can directly extend along the thickness direction D3 towards the opening 180 of the base 10, without bending the movable contact leading-out piece 240, the material of the movable contact leading-out piece 240 is saved.

In addition, the movable contact leading-out pieces 240 extend out of the opening 180 and are connected with the pins 50, and the base 10 does not need to be slotted to accommodate the movable contact leading-out piece 240. On the one hand, the structural strength of the base 10 is guaranteed, the deformation resistance of the base 10 is improved, and the dimensional accuracy of the base 10 is guaranteed with small dispersion; On the other hand, when the contact part 20 and the magnetic circuit part 30 are installed in the base 10, the assembly parameters are consistent, the electromechanical parameters are guaranteed, the reliability of products is improved, and the service life is prolonged.

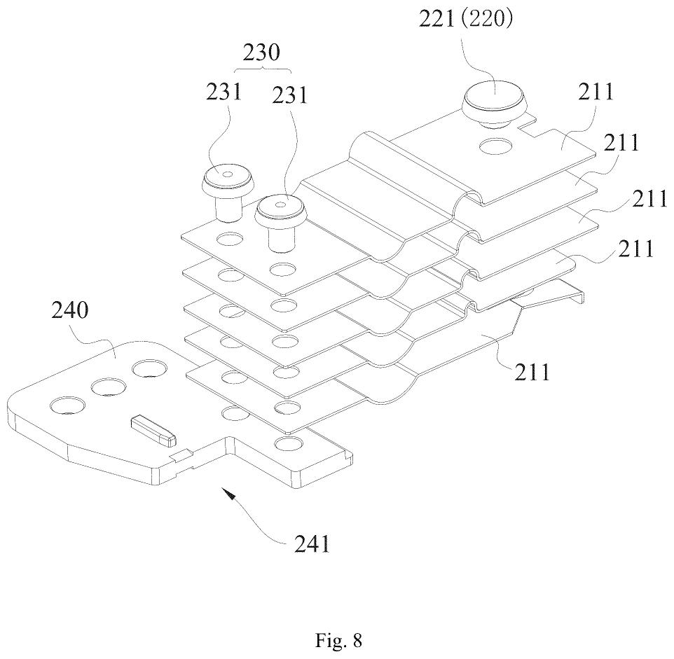

As shown in FIG. 8, the movable contact piece 210 of the movable contact part includes a plurality of sub-contact pieces 211 stacked with each other. In the embodiment of the present invention, the number of the sub-contact pieces 211 is five, but it is not limited to this. For example, the number of the sub-contact pieces 211 can also be two, three, four, six, etc. By designing the movable contact piece 210 to include a plurality of sub-contact pieces 211 stacked with each other, on the one hand, the thickness of the sub-contact pieces 211 is thin, and the movable contact piece 210 can be made of a thin strip material with lower material cost, which is convenient for operation; on the other hand, by increasing or decreasing the number of the sub-contact piece 211 according to the value of the current, the thickness of the movable contact piece 210 can be increased or decreased.

The movable contact unit 220 and the static contact unit 230 are both provided on the movable contact pieces 210. It can be understood that the movable contact unit 220 may be connected to the movable contact pieces 210 in an integral or separate manner, and the static contact unit 230 can also be connected to the movable contact pieces 210 in an integral or separate manner.

When the movable contact unit 220 and the static contact unit 230 are connected to the movable contact pieces 210 in the separate manner, the connection method may be riveting, but this is not limited thereto.

Of course, in other embodiments, the movable contact pieces 210 may also be an integral piece, without the multi-layer sub-contact pieces 211 stacked with each other.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected” can be directly connected, or indirectly connected through an intermediary medium. For the ordinary skilled person in the art, the specific meanings of these terms in the embodiments of the invention can be understood based on the specific circumstances.

In the description of the embodiments of the present disclosure, it should be understood that the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the invention.

In the description of this specification, terms such as “an embodiment,” “some embodiments,” “a specific embodiment” refer to the specific features, structures, materials, or characteristics described in conjunction with the embodiment or example being included in at least one embodiment or example of the invention. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

What is claimed is:

1. A relay, comprising:
a contact part comprising two sets of movable contact parts, each set of the movable contact part comprising a movable contact piece, a movable contact unit, a static contact unit and a movable contact leading-out piece, the movable contact unit being arranged on the movable contact piece; the static contact unit being arranged on the movable contact piece and/or the movable contact leading-out piece; two movable contact units corresponding to two static contact units, respectively; at least one of two movable contact leading-out pieces being provided with an avoidance notch; the static contact unit of the movable contact part having the avoidance notch comprising at least two static contacts, the movable contact unit corresponding to the static contact unit comprising at least two movable contacts, the at least two static contacts and the at least two movable contacts corresponding with each other; and
a push rod assembly comprising a first push rod and a second push rod, the first push rod being movably passing through the avoidance notch of the movable contact leading-out piece of one of the movable contact pars, the first push rod being connected with the movable contact piece of the other the movable contact part; the second push rod being connected with the movable contact piece of one of the movable contact parts.

2. The relay according to claim 1, wherein in each movable contact part, the static contact unit is disposed at a connection position between the movable contact piece and the movable contact leading-out piece.

3. The relay according to claim 1, wherein in each movable contact part, the movable contact piece has a first end and a second end opposite to the first end in a length direction; the movable contact unit is disposed at the first end, the static contact unit is disposed at a connection position between the second end of the movable contact piece and the movable contact leading-out piece;
the first end of one of the movable contact pieces corresponds to the second end of the other one of the movable contact pieces.

4. The relay according to claim 1, wherein one of two movable contact leading-out pieces is provided with the avoidance notch, the static contact unit of the movable contact part without the avoidance notch comprises one or two static contacts, the movable contact unit corresponding to the static contact unit comprises one or two movable contacts.

5. The relay according to claim 1, wherein the relay further comprises a base, the base has an accommodation space, and the accommodation space has an opening communicated with outside of the base;
the contact part is arranged in the accommodation space, the movable contact leading-out piece extends along a thickness direction of the base, and a portion of the movable contact leading-out piece extends out of the base from the opening, the thickness direction is perpendicular to the moving direction of the first push rod.

6. The relay according to claim 1, wherein the relay further comprises a magnetic circuit part, the magnetic circuit part drivably connected with the first push rod and the second push rod;
there are two contact parts respectively arranged on opposite sides of the magnetic circuit part, and one ends of the first push rod and the second push rod are respectively connected with two movable contact pieces of one of the contact parts; the other ends of the first push rod and the second push rod are respectively connected with two movable contact pieces of the other contact part.

7. The relay according to claim 6, wherein in each contact part, at least one of two movable contact leading-out pieces is provided with the avoidance notch;
the first push rod movably passes through the avoidance notch of one of the contact parts, the second push rod movably passes through the avoidance notch of the other one of the contact parts.

8. The relay according to claim 6, wherein the relay further comprises a base, the base has a middle area, a first contact area and a second contact area, the middle area is arranged between the first contact area and the second contact area, the first contact area and the second contact area are spaced from each other along the first direction;
two contact parts are respectively arranged in the first contact area and the second contact area, the magnetic circuit part is arranged in the middle area.

9. The relay according to claim 8, wherein the base comprises:
a first partition, arranged between the first contact area and the middle area;
a second partition, arranged between the second contact area and the middle area.

10. The relay according to claim 8, wherein the base further has a first moving area and a second moving area spaced from each other along the second direction, and the middle area is located between the first moving area and the second moving area; the second direction is perpendicular to the first direction.
the first push rod movably arranged in the first moving area; the second push rod movably arranged in the second moving area.

11. The relay according to claim 10, wherein the first contact area, the first moving area, the second contact area and the second moving area are sequentially connected end-to-end to form a rectangular structure.

12. The relay according to claim 11, wherein among the two contact parts four sets movable contact unit and the static contact unit are located at the four corners of the rectangular structure respectively.

13. The relay according to claim 10, wherein the base further comprises:
a third partition, arranged between the first moving area and the middle area;
a fourth partition, arranged between the second moving area and the middle area.
